(19) United States
(12) Patent Application Publication
(10) Pub. No.: US 2015/0061204 A1
(43) Pub. Date: Mar. 5, 2015

(54) VISE FOR SKATEBOARD

(71) Applicant: Daniel R. Talbot, Mitchell, CA (US)

(72) Inventor: Daniel R. Talbot, Mitchell, CA (US)

(21) Appl. No.: 14/478,384

(22) Filed: Sep. 5, 2014

Related U.S. Application Data
(60) Provisional application No. 61/873,913, filed on Sep. 5, 2013.

(51) Int. Cl. A63C 17/01; B25B 11/00

(52) U.S. Cl. CPC A63C 17/017; B25B 11/00
USPC 269/10

(57) ABSTRACT

An example vise assembly for housing a skateboard is presented. The vise assembly comprises a vise body to support the vise assembly, a vise jaw secured to a bottom portion of the vise body, the vise jaw is used to mount the vise assembly to a structure, a top surface secured to a top portion of the vise body having at least two flat areas, at least two curved areas and a hole to hold the skateboard, and a screw assembly secured to insert a screw into the vise body.

### BACKGROUND

Sporting goods stores offering professional services in various field of sports including skating and repairing damaged skateboards are expected to have suitable skate-holding means mounted on work surface. Such a clamping means secures a skateboard. In many instances, it is desirable to hold elongated work pieces in a vertical or horizontal position, and it is difficult to do with ordinary machine vises mounted on a machine tool table.

### BRIEF DESCRIPTION OF THE DRAWINGS

Examples are described in the following detailed description and in reference to the drawings, in which:

FIGS. 1A-D illustrate a representation of an example vise for a skateboard in accordance with an implementation of the present disclosure; and

FIG. 2 illustrates a representation of an example vise holding a skateboard positioned vertically in accordance with an implementation of the present disclosure.

### DETAILED DESCRIPTION

Various aspects of the present disclosure are directed to a workstation vise designed for the contours of a skateboard. More specifically, and as described in greater detail below, various aspects of the present disclosure are directed to a manner by which the vise securely holds a skateboard in many positions.

Aspects of the present disclosure described herein disclose allowing the user to use their hands during repairs, general maintenance and assembly. Among other things, this approach allows easier maintenance of skateboards. The user can use handle the work related to the skateboard more comfortably and safely.

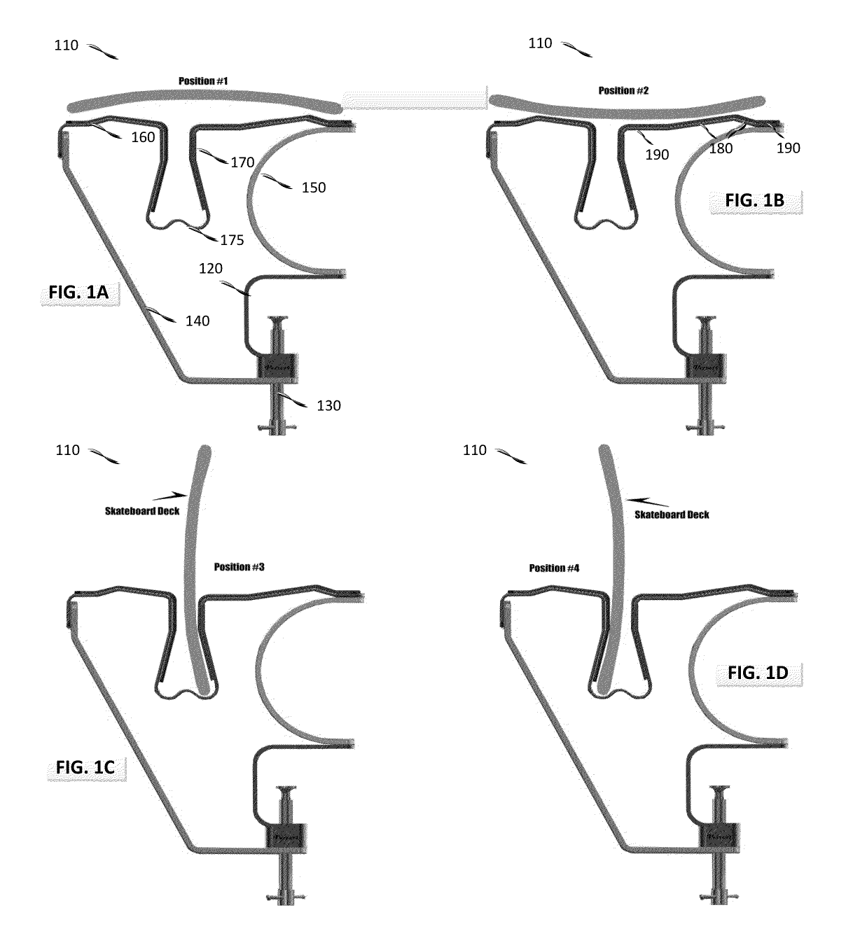

FIGS. 1A-D illustrate an example of a skateboard workstation vise 110. It should be readily apparent that the present illustration should not be interpreted to be limited by this particular illustrative architecture shown in FIGS. 1A-D, and the vise 110 represents a generalized illustration and that other elements may be added or the illustrated elements may be removed, modified, or rearranged in many ways.

The vise 110 comprises a vise jaw, which is a clamp like device, which includes a clamp 120 and a clamp screw 130. The clamp like device is connected to a vise support body 140 and a clearance arch 150. The support body 140 and the clearance arch 150 are connected to a tabletop surface. The tabletop surface includes a rubber grip 160, deck slot 170, inner locking knob 175, inner and outer curves 180, inner and outer tables 190. The inner and outer tables 190 may be flat to create stability when the skateboard is placed on the top surface.

In one implementation, the vise 110 may be stationary or moveable. The vise 110 securely holds a skateboard in many positions. More specifically, FIGS. 1A-D demonstrate each position in which a skateboard deck may be placed on the vise 110 and the connection between the skateboard deck and the inner and outer tables 190. As shown in FIGS. 1A-B, a skateboard may be placed on the surface of the vise 110 facing both up and facing down which creates a molded work area that prevents the skateboard deck from wobbling during use. More specifically, the inner and outer curves 180 and inner and outer tables 190 are designed to lock and hold a skateboard securely with limited obstructions. In other implementations, as shown in FIGS. 1C-D, the deck slot 170 and inner locking knob 175 are custom contours that lock and hold a skateboard securely with limited obstructions. The deck slot 170 and inner locking knob 175 allow a skateboard deck to be inserted. In one implementation, the deck slot 170 and inner locking knob 175 wedge and hold the skateboard deck securely in position. The deck slot 170 and inner locking knob 175 are positioned far from the counter or work table for unobstructed use and clearance, which provides an ergonomically comfortable workstation for the user. Further, the clearance arch 150 allows the user space and access all parts of the complete skateboard assembly without obstructions.

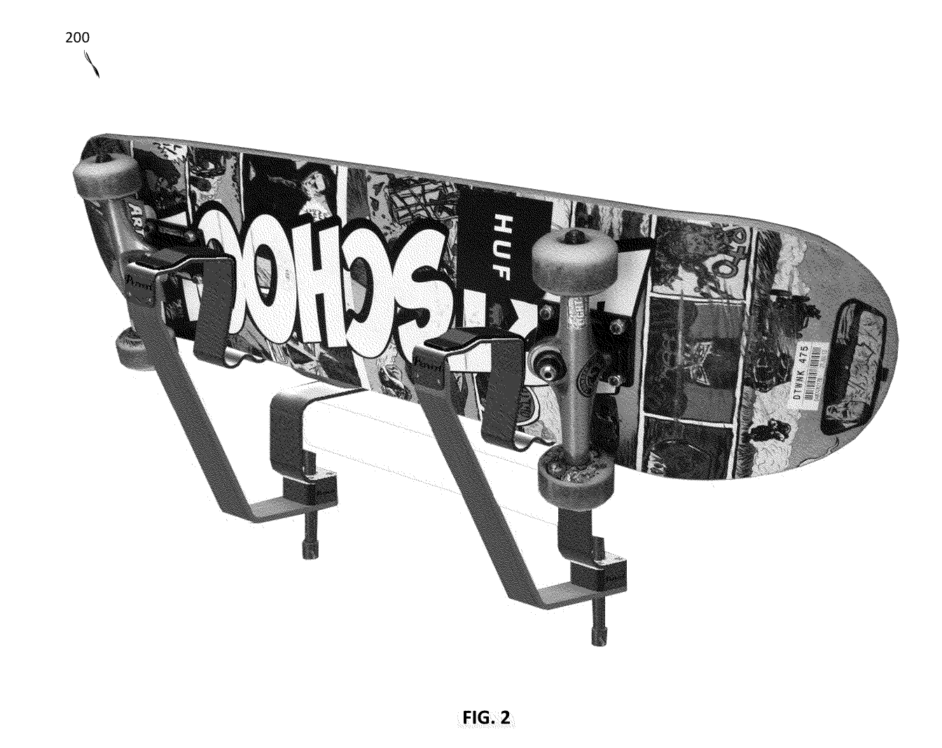

FIG. 2 illustrates an example of a vise assembly (e.g., the vise assembly 110 as shown in FIGS. 1A-D) with a skateboard housed in the hole area. It should be readily apparent that the present illustration should not be interpreted to be limited by this particular illustrative architecture shown in FIG. 2, and the assembly vise with the skateboard stored in a specific orientation represents a generalized illustration and that other elements may be added or the illustrated elements may be removed, modified, or rearranged in many ways.

While the above disclosure has been shown and described with reference to the foregoing examples, it should be understood that other forms, details, and implementations may be made without departing from the spirit and scope of the disclosure that is defined in the following claims.

What is claimed is:

1. A vise assembly for housing a skateboard, comprising:
a vise body to support the vise assembly;
a vise jaw secured to a bottom portion of the vise body, the vise jaw is used to mount the vise assembly to a structure;
a top surface secured to a top portion of the vise body having at least two flat areas, at least two curved areas and a hole to hold the skateboard; and
a screw assembly secured to insert a screw into the vise body.

2. The vise assembly of claim 1, wherein the hole comprises a slot and an interlocking mechanism to hold the skateboard.

3. The vise assembly of claim 2, wherein the slot and the interlocking mechanism lock and hold a skateboard securely with limited obstructions when the skateboard is placed into the slot vertically.

4. The vise assembly of claim 1, wherein the having at least two flat areas and the at least two curved areas lock and hold a skateboard securely with limited obstructions when the skateboard is placed on the top surface horizontally.

5. The vise assembly of claim 2, wherein the slot and the interlocking mechanism is positioned at a predetermined distance from the structure.

6. The vise assembly of claim 3, wherein the predetermined distance is equal or greater than the width of the skateboard.

7. The vise assembly of claim 1, further comprising a screw handle secured to an outer end of the screw to rotate the screw.

8. The vise assembly of claim 1, wherein the structure is a type of surface such as a handle bar, a workstation.
